(19) United States
(12) Patent Application Publication
(10) Pub. No.: US 2005/0188554 A1
(43) Pub. Date: Sep. 1, 2005

(54) Moisture-absorbing collar for a safety razor

(76) Inventor: Norman Kjemhus, Stony Plain (CA)

Correspondence Address: JEAN M. MACHELEDT, 501 SKYSAIL LANE, SUITE B100, FORT COLLINS, CO, 80525-3133, US

(21) Appl. No.: 11/045,670

(22) Filed: Jan. 27, 2005

Related U.S. Application Data
(60) Provisional application No. 60/540,677, filed on Jan. 30, 2004.

(51) Int. Cl. B26B 19/44

(52) U.S. Cl. 30/537; 30/526

(57) ABSTRACT

The present invention is a moisture absorbing collar for the handle of a safety razor. The collar is toroidal or tubular sleeve preferably made of a sponge foam rubber or similar moisture absorbing material. Water accumulating in the shaving head of the razor during shaving runs down the handle from the head and is absorbed by the collar. After shaving, water is removed from the collar by manually compressing the collar or by allowing the collar to air-dry.

### FIELD OF THE INVENTION

This application claims benefit under 35 U.S.C. 119(e) to pending Provisional Patent App. No. 60/540,677 filed 30 Jan. 2004. The present invention relates to the field of safety razor. In particular, the present invention relates to a moisture-absorbing collar for the handle of a safety razor.

### BACKGROUND OF THE INVENTION

When wet shaving with a safety razor, water accumulates in the shaving head of the razor and will eventually run down the handle of the razor and either drip onto the floor or bathroom counter or down the hands and wrist of the person shaving. This can be very annoying to the person shaving and causes a mess. It is, therefore, desirable to have means to absorb water from the shaving head of a safety razor before it runs off of the handle.

### SUMMARY OF THE INVENTION

The present invention is a moisture-absorbing collar that is fitted circumferentially around the handle of a safety razor. Preferably, the collar is a toroidal or tubular sleeve that slides onto the handle and positioned around the throat of the handle, the throat being the upper end of the handle just beneath the shaving head of the razor.

The collar may be made of sponge foam rubber or similar moisture-absorbent material. Sponge foam rubber is a suitable material in that it is very absorbent and may be compressed to release moisture contained in the foam rubber or can be left in the open to air-dry by allowing moisture to evaporate naturally.

By positioning a moisture-absorbing collar around the throat of a safety razor handle, water that accumulates in the shaving head during shaving runs down from the head along the handle and encounters the collar where it is absorbed.

The collar may be glued into position on the handle or it may be held in place by friction by having the opening of sleeve smaller than the diameter of the shaver handle whereby the collar is stretched and placed under tension around its circumference as it is slid onto the handle, holding its position around the throat of the handle.

It is envisioned that the present invention is suitable for disposable and non-disposable safety razors. It is also envisioned that the present invention is suitable for safety razors intended for both men and women.

Broadly stated, one aspect of the present invention is a moisture-absorbing collar for a safety razor, the safety razor having a handle with a throat.

Broadly stated, another aspect of the present invention is a safety razor having a handle with a throat, the safety razor comprising a moisture-absorbing collar circumferentially disposed about the throat of the handle.

### BRIEF DESCRIPTION OF THE DRAWINGS

FIG. 1 is a perspective view of a safety razor.

FIG. 2 is a perspective view of the moisture-absorbing collar of the present invention.

FIG. 3 is a perspective view of a safety razor with a moisture-absorbing collar.

FIG. 4 is a side view of a safety razor with a moisture-absorbing collar.

### DETAILED DESCRIPTION OF THE PREFERRED EMBODIMENT

The present invention is a moisture-absorbing collar for a safety razor. As shown in FIG. 1, a typical safety razor 12 comprises a shaving head 14 attached to a handle 16. Handle 16 has a grip portion 18 on its lower end and a throat portion 20 on its upper end located beneath shaving head 14.

Referring to FIG. 2, moisture-absorbing collar 10 is a toroidal or tubular sleeve having interior opening 22 extending through collar 10, an outside diamter 24 and a wall thickness 26. Collar 10 is preferably made of sponge foam rubber but may be made of similar absorbent and elastic materials as known to those skilled in the art. Collar 10 is preferably ¼″ to 1″ in length and an outside diameter 24 of ⅜″ to ¾″ or more depending on the size and shape of handle 16.

Accordingly, wall thickness 26 ranges, preferably, from ⅛″ to ¼″. Opening 22 is sized smaller than the diameter of handle 16 such that collar 10 is stretched around its circumference as it is slid onto throat 20 of handle 16. The tension placed on collar 10 as it is stretched to slid onto handle 16 keeps collar 10 in position around throat 20.

Collar 10 may be held in position around throat 20 by the friction fit or it may also be glued into position with a suitable adhesive as known to those skilled in the art. Collar 10 may be made from strips of moisture-absorbing material and glued into sleeves with a suitable adhesive. Collar 10 may also be stamped or cut out of sheets of moisture-absorbing materials as toroidal or tubular sleeves thereby negating the extra manufacturing steps of gluing strips into sleeves.

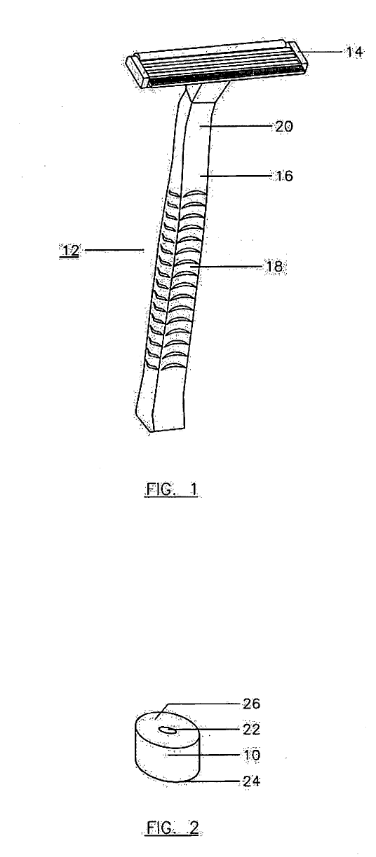

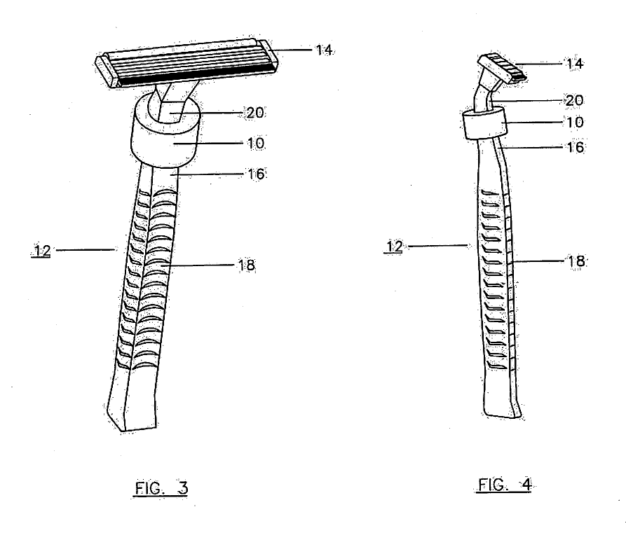

Referring to FIGS. 3 and 4, collar 10 slid onto handle 16 up to throat 20 just beneath shaving head 14. Water accumulating in shaving head 14 during shaving runs down handle 16 and encounters collar 10 where it is absorbed. After shaving, water is released from collar 10 by manually compressing collar 10 or by allowing collar 10 to air-dry and have water evaporate from it naturally.

Although a few preferred embodiments have been shown and described, it will be appreciated by those skilled in the art that various changes and modifications might be made without departing from the scope of the invention. The terms and expressions in the preceding specification have been used therein as terms of description and not of limitation, and there is no intention in the use of such terms and expressions of excluding equivalents of the features shown and described or portions thereof, it being recognized as the scope of the invention as defined and limited only by the claims that follow.

1. A moisture-absorbing collar for a safety razor, the safety razor having a handle with a throat.

2. The collar as set forth in claim 1 wherein said collar is adapted to be circumferentially disposed around the handle of said safety razor.

3. The collar as set forth in claim 2 wherein said collar is adapted to be circumferentially disposed around the throat of said handle.

4. The collar as set forth in claim 3 wherein said collar is a toroidal or tubular sleeve.

5. The collar as set forth in claim 4 wherein said collar is made of sponge foam rubber.

6. A safety razor having a handle with a throat, the safety razor comprising a moisture-absorbing collar circumferentially disposed around the throat of the handle.

7. The safety razor as set forth in claim 6 wherein said collar is a toroidal or tubular sleeve.

8. The safety razor as set forth in claim 6 wherein said collar is made of sponge foam rubber.
